(19) United States
(12) Patent Application Publication
(10) Pub. No.: US 2004/0028057 A1
(43) Pub. Date: Feb. 12, 2004

(54) Method and system for rating a packet based communication

(76) Inventors: Ivor Benjamin, Wayne, PA (US); T. Scott Cashon, Philadelphia, PA (US); Joseph Piazza, Philadelphia, PA (US)

Correspondence Address: Pepper Hamilton LLP, One Mellon Center, 500 Grant Street, 50th Floor, Pittsburgh, PA, 15219, US

(21) Appl. No.: 10/446,563

(22) Filed: May 28, 2003

Related U.S. Application Data
(60) Provisional application No. 60/389,771, filed on Jun. 19, 2002.

(51) Int. Cl. H04L 12/56

(52) U.S. Cl. 370/395.52

(57) ABSTRACT

A method and system for rating a packet based telephone call determines a source, and optionally a destination location of an Internet Protocol (IP) telephone call based on information contained within a call detail record. The locations are used to rate the call into any of a number of categories including local and long distance. In the case of hybrid calls which are packet based in part but which also traverse the Public Switched Telephone Network (PSTN), the method and system can identify the call as a gateway based call and rate the call appropriately.

### RELATED APPLICATIONS AND CLAIM OF PRIORITY

This application claims priority to, and incorporates by reference, the co-pending provisional application serial No. 60/389,771, entitled “Call Rating in Packet Telecommunications Networks.”

### BACKGROUND OF THE INVENTION

From its inception, the telephone industry has relied upon charging customers for calls as its primary source of income, with the charges being based on a number of factors, one of the most important being the distance of the call, others being the time of day of the call, day of week of the call, and whether the call was placed on a holiday. This model has survived decades of innovation and change in the telecommunications industry. Although there have been tremendous reductions in the costs for both residential and business telephone service, customers still expect to be charged according to these parameters. Furthermore, they expect to see a bill with a detailed listing of the calls and charges.

The advent of the Internet, coupled with the development of “packet” based communications networks that route signals in discrete packages as opposed to sending them over fixed “circuits”, has resulted in the creation of packet based telephone systems, most notably Internet Protocol (IP) telephone systems. Packet based telephone systems are based upon the use of telephones that function in a manner similar to that of a regular telephone, but which rely on transmission of signals over a packet based network instead of a traditional telephone circuit. Using a packet based network for the transmission of voice data can be more efficient since the voice signal is packetized and sent with other data. During lapses in conversation it is possible to suppress the transmission of packets. Thus, no transmission bandwidth is required during idle times. Packet based telephone signals can be routed over a wide variety of networks, including the Internet. Thus, very extensive connectivity already exists.

Packet based telephone systems can offer many advanced features and tremendous flexibility in terms of how calls are forwarded and in how telephone numbers can be moved. As an example, with a packet based telephone system, it is possible for a user to change locations (e.g., travel from the primary office of a business to a remote office such as a regional or home office) while maintaining the same telephone number. In this scenario, the user typically takes an IP or other packet based telephone with him or her and simply plugs it into the IP or other packet based network at the regional office. When that user's primary office number is dialed, the packet based network routes the call to the user's remote office and the user's phone rings at the remote office. If the user dials a number from the remote office using his or her packet based telephone, the caller ID of the called party will show the user's number from the main office, regardless of the fact that the user is at the remote office. Packet based telephony thus offers a level of flexibility heretofore unavailable to businesses and individuals except on mobile (cell) phones, which are costly and which generally do not have the same quality and feature sets as fixed (wireline) telephones.

The inherent flexibility of packet based telephony also leads to difficulties in billing for those services. In the example mentioned above, if the user is calling someone a few blocks away from the remote office, the call may only be traversing a few blocks or miles and is thus clearly a “local” call. Nevertheless, based on area codes the call could potentially appear to be a long distance call. Similarly, if the user dials a number in the primary office from the remote office the call may appear, based on area codes and exchanges, to be a local call, but may actually be traversing a distance of hundreds or thousands of miles.

Packet based telephone systems change the economics of telecommunications, making distance less important, at least in theory, since the packets may be routed along a path that has excess capacity and thus is essentially “paid for” already by data traffic. Nevertheless, customers are used to, and willing to pay for, telephone services based on call distance, duration, and time of day. Service providers are interested in using packet based telephone systems to provide the same or higher quality of service (including calling features) at a lower cost. It is not in their interest, however, to completely undermine the circuit based pricing schemes by offering flat rate billing for long distance calls.

Additionally, there are complex payment systems between long distance telephone companies and local telephone companies that are used to subsidize the cost of local telephone service in order to keep basic local telephone services affordable. The payments between long distance carriers and local telephone companies, called “access charges,” amount to billions of dollars per year. Rapid adoption of IP telephony with inappropriate billing systems could undermine the economics of the telephone system because long distance packet based calls could be rated and billed as local calls, thus avoiding access charges. Such a system would result in the undermining of the current regulatory scheme and could result in the inability of local telephone companies to provide low cost basic telephone service to all customers

Further, because in the future many calls may be “hybrid” packet based and circuit based calls, where one or more parties on a call are using a packet based system while one or more other parties on the same call use a traditional circuit based system, it is desirable to provide consistency in billing all parties on such a call. Such consistency would also allow regulators and regulated service providers to account for transfer payments, regulatory fees, and other payments that must be paid to other regulated service providers. In summary, the regulatory system at the federal, state, and local levels has been established based on call rating and billing in a circuit switched environment. The present concept of packet based telephony could undermine this system and result in undesirable economics for telephone companies and subsequently their customers.

Thus, it is desirable to provide a method and system that is useful in determining charges for packet based telephone calls, where the charges are based on traditional factors such as area code, geographic location, time of day, day of the week, and/or holidays. It would also be desirable to have a packet based rating and billing system that support the charging of calls based on new factors, such as bandwidth and/or Quality of Service (QoS) separately, or in combination with the traditional circuit switched factors previously mentioned. By having a rating and billing system that allowed the operator to emulate a traditional circuit switched infrastructure, and which also allowed for migration to a packet based infrastructure, the operator could have flexibility in how calls are billed and how the investments in both circuit switched and packet switched infrastructures are recovered.

### SUMMARY OF THE INVENTION

The present invention provides a method and system for rating packet based telephone calls so that a bill can be generated and customers can be charged on a basis that is analogous to the circuit switched world. This can include billing based on distance, time of day, day of the week, holidays, and/or other factors.

Furthermore, a flexible method of assigning and changing rates is preferred, so that service providers can rapidly put in place and update the customer's rate plan. Preferably, the method and system for rating calls and generating bills should work in both the context of the traditional telephone network, having 10 digit numbers (area code, exchange and extension), as well as in the context of the packet based telephone system where a network address (e.g., IP address) and device identifier (e.g., Media Access Control or MAC address) are used to identify the user's telephone and location.

Preferably, the system for rating should be able to operate in both a pure packet (e.g. IP telephony) environment, as well as in a hybrid environment in which part of the call traverses a circuit switched network such as the Public Switched Telephone Network (PSTN). In instances where the call is a hybrid packet/circuit based call, a preferred embodiment can also determine an approximate cost of the call so that the profitability of the call—and optionally the need for additional gateways—can be determined.

In one embodiment, a call detail record is received which describes the call that was made. Under certain conditions, the call detail record may include the called party number and calling party number, as well as a network address and device identifier. In the case of IP telephony, the network address is the IP address. However, other appropriate addresses may be used in other packet-based networks.

Information that is extracted from the call detail record includes network addresses from the first and second stations. By mapping these network addresses to locations, the call can be rated based on locations or distance between the locations.

With the information obtained from the call detail record, in accordance with a preferred embodiment a rating template or procedure is retrieved that allows the call to be rated into a particular service class (e.g., local, toll free, directory assistance), and a charge may be generated based on the service class. Other parameters, such as time of day, discount plan, bandwidth, and/or quality of service may also come into play to generate the final charge for the customer.

Once the charges have been calculated, they can be stored in a database for subsequent retrieval and/or for the generation of a printed or electronic bill. In some instances a device identifier (e.g., MAC address) may be extracted from the call detail record so that the call can be associated with a device and a user.

In a hybrid packet/circuit based call, part of the call traverses a packet network and part of the call is over a traditional circuit switched network. In a preferred embodiment, for these types of hybrid systems a directory number is extracted from the call detail record in addition to the network address. Mappings that relate network address to location and directory number to location are used to establish the first location and second location, and to place the call in the appropriate service class based at least on those locations or the distance between those locations. A device identifier may also be extracted and used to relate the device to a user.

For hybrid packet-circuit based calls, the call enters the circuit network through a gateway that may or may not be located near the destination location. One of the features of a preferred embodiment of the present invention is that it can be used to calculate the actual or approximate cost for the call based on the packet and circuit based portions of the call. Since the cost will be dependent on the location of the gateway this calculation can be useful in determining when and where new gateways are required.

A preferred embodiment of the present invention allows a service provider to charge customers for packet based telephone calls according to a service plan that is similar to the circuit based pricing plans to which customers are accustomed. This approach may result in rapid customer acceptance of the packet based telephone system, and it may provide substantial margins for the service provider. The problems associated with flat rate billing and other billing schemes that are cost based may be avoided by rating the packet based calls on traditional factors, such as distance or location. Customers can thus receive the added benefits and features of packet based telephone systems, such as IP telephony, while service providers can avoid the pitfalls of cost-based and flat rate billing.

The present invention allows for the operator to rate and bill calls based on traditional circuit switched parameters, packet based parameters, or a combination thereof, and to calculate the various payments due under the present regulatory schemes, while allowing evolution to packet based costs and billing.

A preferred embodiment of the invention can be summarized as follows: A method for rating a call in a packet based environment includes the steps of (i) extracting a first portion of data from a call detail record corresponding to the call wherein the first portion of the call detail record contains at least a first network address representing a first station; (ii) extracting a second portion of data from the call detail record corresponding to the call wherein the second portion of the call detail record contains at least a second network address representing a second station; (ii) retrieving a mapping, wherein the mapping relates the first network address representing the first station to a first location and the second network address representing the second destination station to a second station; and (iv) rating the call to place the call in a service class based on at least the first location and the second location.

In this embodiment, optionally and preferably the first network address and/or the second network address are Internet Protocol (IP) address(es), although other addresses in packet based and related systems may be used. The service class may be selected, for example, from a group including directory assistance, toll free, 900/976 numbers, 911, intra service (on site), intra service (off site), inter service, local calls, long distance domestic, long distance international, and international.

In accordance with an alternate embodiment, a method for rating a call in a packet based environment and for assigning that call to a user includes the steps of (i) extracting a first portion of data from a call detail record corresponding to the call wherein the first portion of the call detail record contains at least a first network address representing a first station; (ii) extracting a second portion of data from the call detail record corresponding to the call wherein the second portion of the call detail record contains at least a second network address representing a second station; (iii) extracting a third portion of data from the call detail record corresponding to the call wherein the third portion of the call detail record contains at least a first device identifier associated with the first station; (iv) retrieving a first mapping, wherein the first mapping relates the first network address representing the first station to a first location and the second network address representing the second destination station to a second station; (v) rating the call to place the call in a service class based on at least the first location and the second location; (vi) retrieving a second mapping, wherein the second mapping relates the first device identifier with a user; and (vii) assigning the call to the user.

In this embodiment, optionally and preferably the first network address and/or the second network address are Internet Protocol (IP) address(es), although other addresses in packet based and related systems may be used. Further, the device identifier may be a Media Access Control (MAC) address.

In accordance with an alternate embodiment, a method for rating a call in a packet based environment having at least one packet based telephony gateway includes the method comprising the steps of: (i) extracting a first portion of data from a call detail record corresponding to the call wherein the first portion of the call detail record contains at least a first network address representing a first station; (ii) extracting a second portion of data from the call detail record corresponding to the call wherein the second portion of the call detail record contains at least a directory number representing a second station; (iii) retrieving a first mapping, wherein the first mapping relates the first network address representing the first station to a first location; (iv) retrieving a second mapping, wherein the second mapping relates the directory number to a second location; and (v) rating the call to place the call in a service class based on at least the first location and the second location.

In this embodiment, optionally and preferably the first network address is an Internet Protocol (IP) address, although other addresses in packet based and related systems may be used.

In accordance with an alternate embodiment, a method for rating a call in a packet based environment having at least one packet based telephony gateway, the method comprising the steps of: (i) extracting a first portion of data from a call detail record corresponding to the call wherein the first portion of the call detail record contains at least a first network address representing a first station; (ii) extracting a second portion of data from the call detail record corresponding to the call wherein the second portion of the call detail record contains at least a directory number representing a second station; (iii) extracting a third portion of data from the call detail record corresponding to the call wherein the third portion of the call detail record contains at least a first device identifier associated with the first station; (iv) retrieving a first mapping, wherein the first mapping relates the first network address representing the first station to a first location; (v) retrieving a second mapping, wherein the second mapping relates the directory number to a second location; (vi) rating the call to place the call in a service class based on at least the first location and the second location; (vii) retrieving a third mapping, wherein the third mapping relates the first device identifier with a user; and (viii) assigning the call to the user.

In accordance with an alternate embodiment, a method for rating a communication includes the steps of: (i) determining a source identifier for a communication that is transmitted over a packet based network; (ii) determining a destination identifier for a communication; and (iii) rating the communication based on the source identifier to the destination identifier.

These and other features and objects of the invention will be more fully understood from the following detailed description of the preferred embodiment that should be read in light of the accompanying drawings. It is to be understood that the invention is not limited in its application to the details of construction and to the arrangements of the components set forth herein or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception upon which this disclosure is based may readily be used as a basis for designing other structures, methods and systems for carrying out the several purposes of the invention. Thus, the invention is not limited to the exact construction and operation illustrated and described, and accordingly all appropriate modifications and equivalents may fall within the scope of the invention.

### BRIEF DESCRIPTION OF THE DRAWINGS

FIG. 1 illustrates an exemplary packet based network with two IP telephones and a traditional circuit switched telephone connected to a gateway that is subsequently connected to the packet based network;

FIG. 2 illustrates a representative network on which the present invention can be implemented;

FIG. 3 illustrates a context diagram for a call rating and billing system;

FIGS. 4A and 4B illustrate entity-relationship diagrams for relating a call detail record to other tables/databases;

FIG. 5 illustrates a data-flow diagram for a call rating and billing system;

FIG. 6 illustrates tables that relate packet based addresses to locations/LATAs, device addresses to IP addresses, and source/destination number to location mapping, respectively;

FIGS. 7A-7C represent flowcharts for call rating and billing, respectively; and

FIG. 8 illustrates a representative bill for a packet based telephone system customer.

### DETAILED DESCRIPTION OF THE PREFERRED EMBODIMENTS

In describing a preferred embodiment of the invention and as illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose. For example, as used herein, the terms “packet based telephony”, “packet telephony”, “packet based telephone calls”, “packet based calls”, “packet telephone calls”, and similar terms include, and are not limited to, voice or sound transmissions over: (i) an IP network; (ii) frame relay; (iii) an asynchronous transfer mode (ATM) network; (iv) dense wavelength division multiplexing transmission systems; (iv) cable television networks and cable modems; (v) digital subscriber lines (DSL); (vi) a wireless local area network (WLAN), such as those following the IEEE 802.11, IEEE 802.11b, or IEEE 802.11g standards; (vii) Ethernet; (viii) token ring; (ix) satellite; and/or (x) X.25. Other packet based or packet-using transmission systems and networks are also included.

The terms “circuit based calls”, “circuit switched calls”, and similar terms refer to the traditional telephone system where voice or sound transmissions are transmitted over a traditional, circuit-based wireline or wireless telephone network. Such transmissions can include, but are not limited to, transmission in DS0 timeslots in a DS 1 or E1 frame based transmission network.

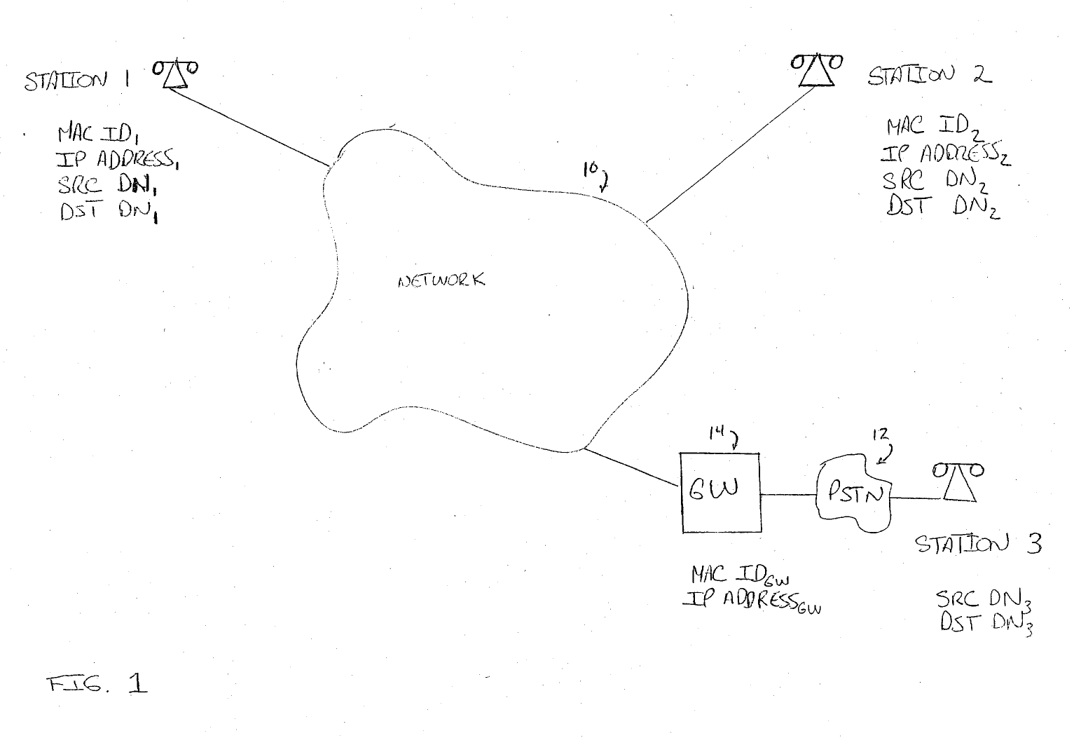

FIG. 1 illustrates a representative network for a packet based telephone call, such as an IP telephony call that travels over the Internet. As shown in FIG. 1, station 1 may receive and initiate calls and has a Media Access Control ID (MAC ID₁), an IP address (IP ADDRESS₁), a source directory number (SRC DN₁) and a destination directory number (DST DN₁) associated with it. Other features are possible, depending on the type of network. In the example shown, the source directory number and destination directory number are the ten-digit number typically referred to as a phone number. It is not necessary that either number have exactly ten digits. For example, an international call may require more than ten digits, while special numbers such as emergency or directory assistance numbers may require only three digits. Further, in the future standard numbers may have more than ten digits, and they may use letters or symbols such as the “#” or “*” symbols presently found on telephones. Any number of digits or symbols is included within the scope of the present invention.

Station 1 is connected to a network 10 such as the Internet. Other types of private or public packet networks can be used, including but not limited to IP based or other packet intranets, ATM networks, frame relay networks, dense wavelength division multiplexing, cable networks, DSL, WLAN, Ethernet, token ring, satellite, X.25, or other types of non circuit-switched networks.

As illustrated in FIG. 1, a second station, station 2, is also connected to the network 10 and can receive calls through the receipt of packets addressed with its IP address (IP ADDRESS2). In this illustrated embodiment, standard IP routing protocols are used to send the packets over the network, and in the case of IP telephony, standardized protocols exist to support the conversion of the destination directory number to an IP address. These protocols include and are not limited to the Media Gateway Control Protocol (MGCP), Simple Gateway Control Protocol (SGCP), H.323, and Session Initiation Protocol (SIP). As a result, the user of station 1 can simply pick up the handset or otherwise activate a speaker and receiver, dial a destination directory number and have the receiver at station 2 signal a user that a call is arriving, preferably with the caller ID indicating the source directory number. The IP telephone system thus provides all of the features of a traditional circuit switched network but utilizes a packet based infrastructure to accomplish the call. Other packet based networks operate in a similar fashion.

FIG. 1 also illustrates a “hybrid” connection between the packet network and the traditional Public Switched Telephone Network (PSTN) 12 through a gateway (GW) 14. The gateway 14 typically has a MAC address (MAC ID_{GW}) and an IP address (IP ADDRESS_{GW}). This enables the gateway 14 to receive IP telephony calls and translate them to a format acceptable for the PSTN. However, other addresses or identifiers are possible. In the example illustrated in FIG. 1, station 3 is connected to the PSTN 12 and has a source directory number SRC DN₃ and a destination directory number DST DN₃. Station 3 is typically a standard telephone connected to a standard telephone jack. Alternatively, station 3 can be an ISDN phone, a telephone that is part of a PBX, or other speaker/receiver device operative with the circuit-based portion of the network.

Calls made over the packet network through the PSTN 12 or otherwise through a link between a packet based network and a circuit based network are hereafter referred to as “hybrid” calls, indicating that they use both the packet network and the circuit switched network. Given that IP telephones are not universally deployed at the time of this application, many, if not the majority, of calls presently made over a packet network use the PSTN at one end of the call. The gateway facilitates the translation of the call from the packet network to the PSTN and visa versa. Hybrid calls also may include conference calls, whereby one or more participants in the conference call connect via a packet based network and one or more participants use a traditional, circuit based network.

It is often the case that the gateway 14 is not located near station 3, thus the PSTN call leg that is traversed can be extensive. As an example, a user in Philadelphia, Pa. may have an IP telephone connected to the Internet. The user may dial a number that relates to a receiver in another state or even country. That number may not be an IP telephone, and in fact there may not be a gateway in the local vicinity of that location. In that instance, the call will be routed to a gateway in another location. As an example, if the user in Philadelphia dials a number in Portland, Oreg., the IP based call may be routed to a gateway in San Francisco, Calif. in which case the call may enter the PSTN in San Francisco and be routed to Portland. In this example, the IP leg of the route is Philadelphia to San Francisco, while the PSTN leg of the route is San Francisco to Portland.

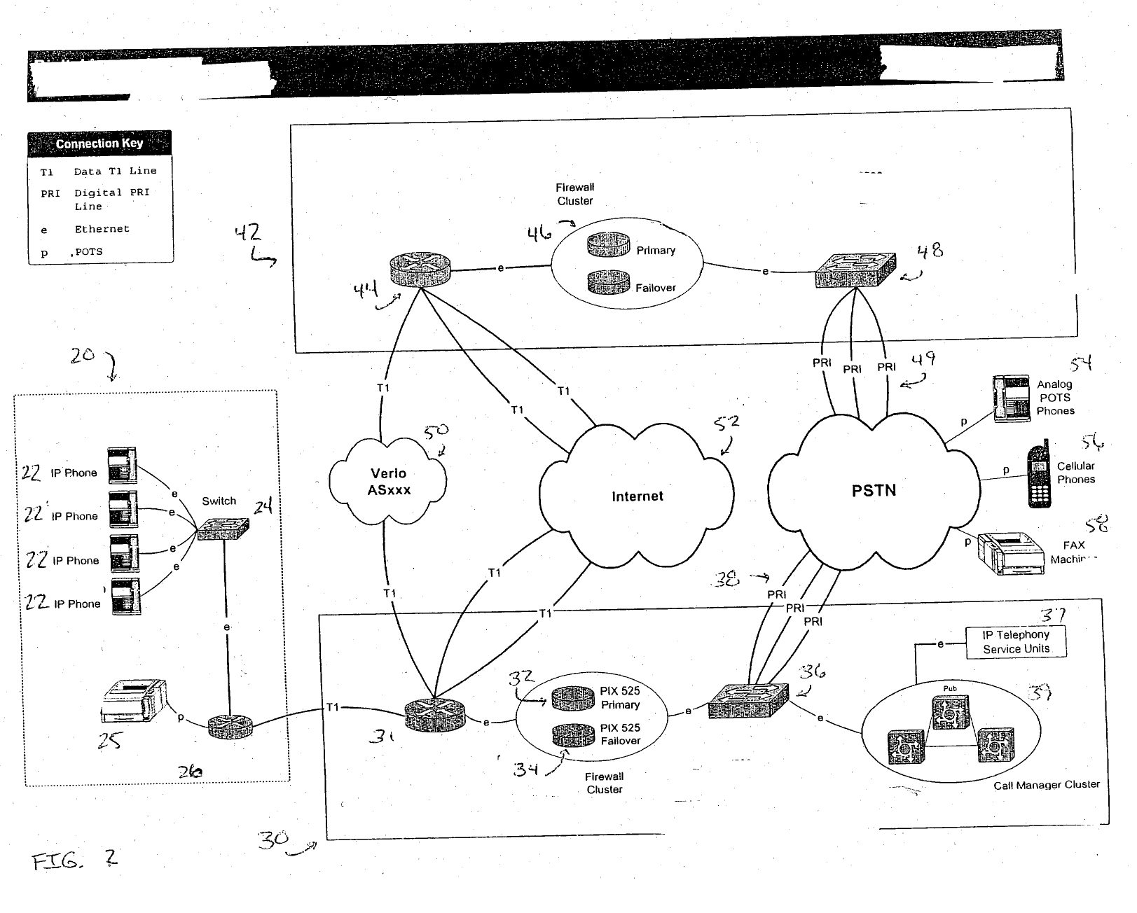

FIG. 2 illustrates a representative network on which the call rating and billing system can be implemented, including a customer site 20 having a router, IP telephones 22 and a switch 24. Representative devices that can perform these functions include, and are not limited to, the Cisco 1751 router, Cisco 7960 IP Phone and the Catalyst 3524XL-EN-PWR switch that can be interconnected using Ethernet or another communications system. It should be noted that when particular equipment is described herein, it is representative in nature only and the invention is in no way limited or constrained to that particular equipment or configuration. Referring again to FIG. 2, an analog fax machine 24 can be connected to an interface unit 26 (e.g., Cisco VIC-2FXS card in a gateway router) which allows the analog fax signal to be encapsulated in a packet based call. In the example shown, the gateway from the customer site is located in Valley Forge, Pa., and is connected to a Point of Presence (POP) 30 in Philadelphia, Pa. The connection between the customer site 20 and the POP 30 is made via a Ti to a core router (e.g., Cisco MSFC2), although this is only one example of a possible connection type. Other means of connectivity, including wire-based and wireless connectivity, are possible. In the example, the service provider operating the POP 30 also provides Internet access to the customer. In the example, the core router is attached to a firewall which is connected to the service provider's edge router. This edge router peers with Internet carriers. Thus, the edge router routes requests for web pages and other Internet content to the Internet via one or more Ti lines. Other means of connectivity, including wire-based and wireless connectivity, are possible. However, it is not necessary for the present invention that the service provider also provide the customer with Internet access.

FIG. 2 also illustrates the preferred configuration of the POP 30 including a firewall cluster comprising a Cisco PIX 525 primary firewall 32 and a Cisco PIX 525 fail over firewall 34. The firewall cluster is connected to an IP telephony gateway 36 (in this example, a Catalyst 6506 WS-X6608-T1 with three transcoders, three ISDN Primary Rate Interfaces [PRIs], and two conference bridges). The gateway connects to the PSTN 40 via three PRIs 38. A call manager cluster 39, in the preferred embodiment including a Cisco Call Manager, is also resident in the POP, and serves to manage the configuration, functionality and signaling for the IP phones at the customer sites. These IP telephony service units 37 appear local to the call manager cluster that simply accesses them over the Ethernet.

FIG. 2 also illustrates a remote site 42, which in this case is the site in Boca Raton, Fla. The remote site contains an edge router 44, a firewall cluster 46, and a gateway 48. The remote edge router 44 is connected to a private IP network 50 (in this example the network operated by Verio) which provides IP interconnectivity, preferably with a guaranteed Quality of Service. The edge routers in both the POP and the remote location are also connected to the Internet 52. Although it is preferable to use the private IP network for IP telephony services, those call can also be routed over the Internet. Gateways at both the POP 30 and the remote site 42 are connected to the PSTN 40, which provides global interconnectivity to analog POTS (i.e., “plain old telephone system”) phones, cellular phones, and fax machines. Other network configurations are possible for other packet based networks.

Operation of the representative network illustrated in FIG. 2 is as was described for the generic network of FIG. 1. Packet telephone calls are routed directly onto the network (private or public), and when the calls are packet phone to packet phone, they do not need to traverse the PSTN 40. Hybrid calls are routed to the most appropriate remote site/POP where the call is then converted from a packet based call to a circuit switched call and placed on the PSTN 40.

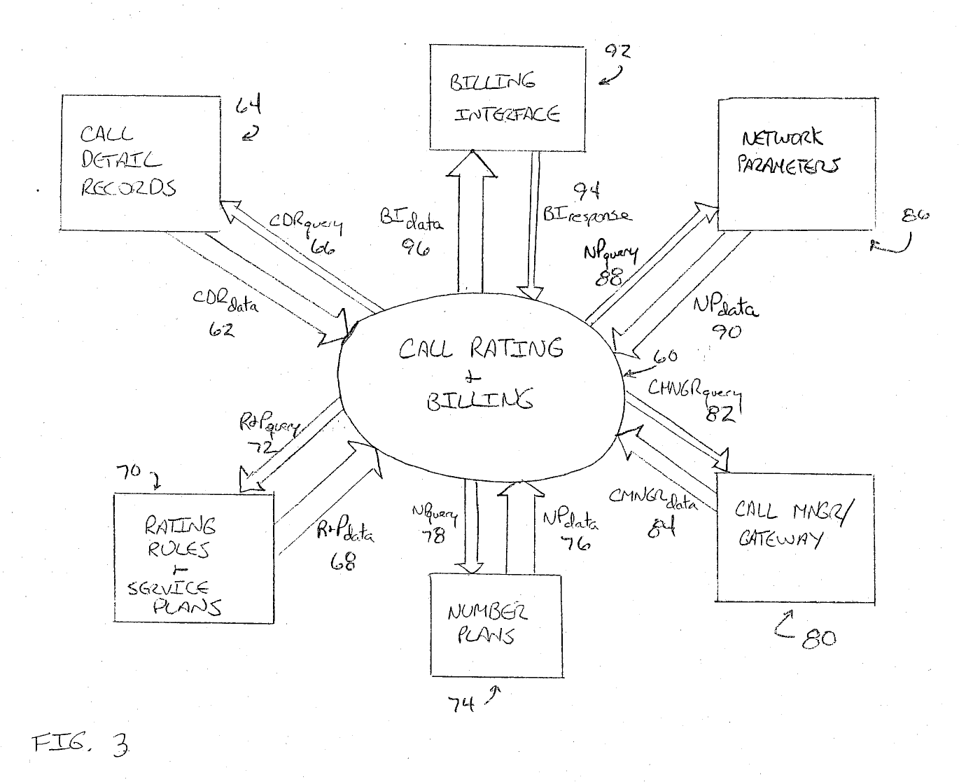

FIG. 3 illustrates a context diagram for the present invention and represents the preferred processes of the invention as it relates to other entities. As shown in FIG. 3, in a preferred embodiment the Call Rating and Billing System 60 obtains call detail records (CRD_{data}) 62 from a Call Detail Records subsystem/module 64 through a CRR_{query} 66. The Call Rating and Billing System 60 can use a variety of rules and service plans to make the determination as to the service class and charge for a call, and obtains rules and plans (R&P_{data}) 68 through a R&P_{query} 72 to the Rating Rules and Service Plans module 70. Number plans are stored in a Number Plan module 74 and relate directory numbers to areas and locations. The Call Rating and Billing System 60 may access this information through a Number Plan query (NP_{query}) 78 and receive the data in NP_{data 7}6. One or more Call switch/Gateway subsystems 80 may be present providing an interface between the packet network and the PSTN. Specifics regarding the configuration of the packet telephony devices on the network and the interface to the PSTN can be obtained by the Call Rating and Billing System through a CMNG_{query} 82 which returns CMNG_{data} 84. Network parameters such as IP addresses, routing tables and other types of information that describe the configuration and operation of the network can be obtained from a Network Parameters module 86 by a NP_{query} 88, which returns NP_{data} 90. Finally, a Billing Interface module 92 can be present to provide a final invoice to customers in an electronic and/or printed format. The Billing Interface provides a query to the Call Rating and Billing System through BIᵣₑₛₚₒₙₛₑ 94, with the data being sent to as BI_{data} 96.

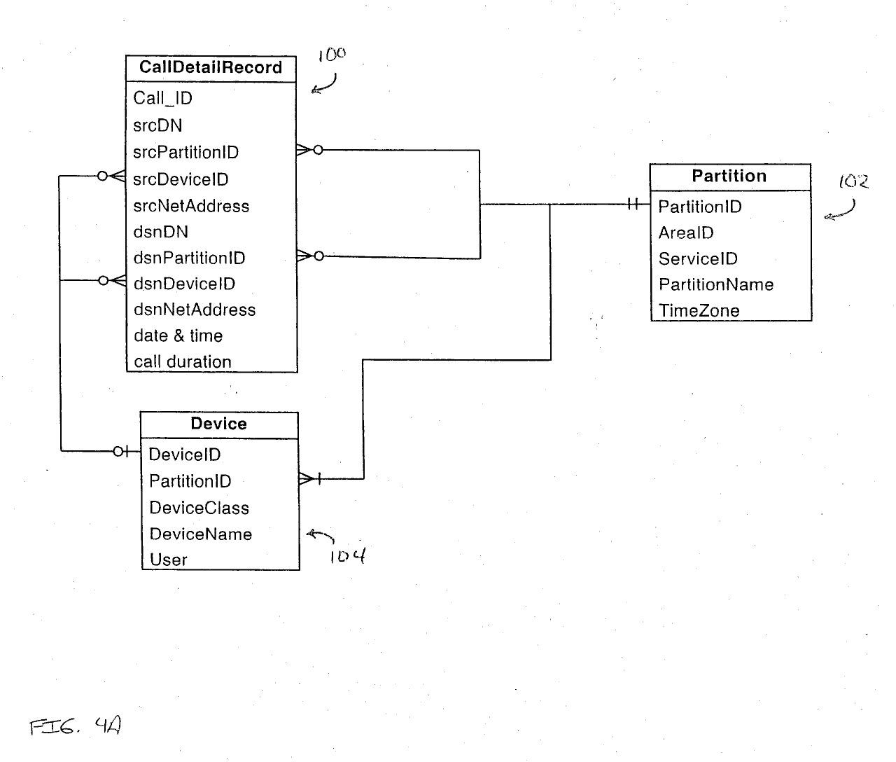

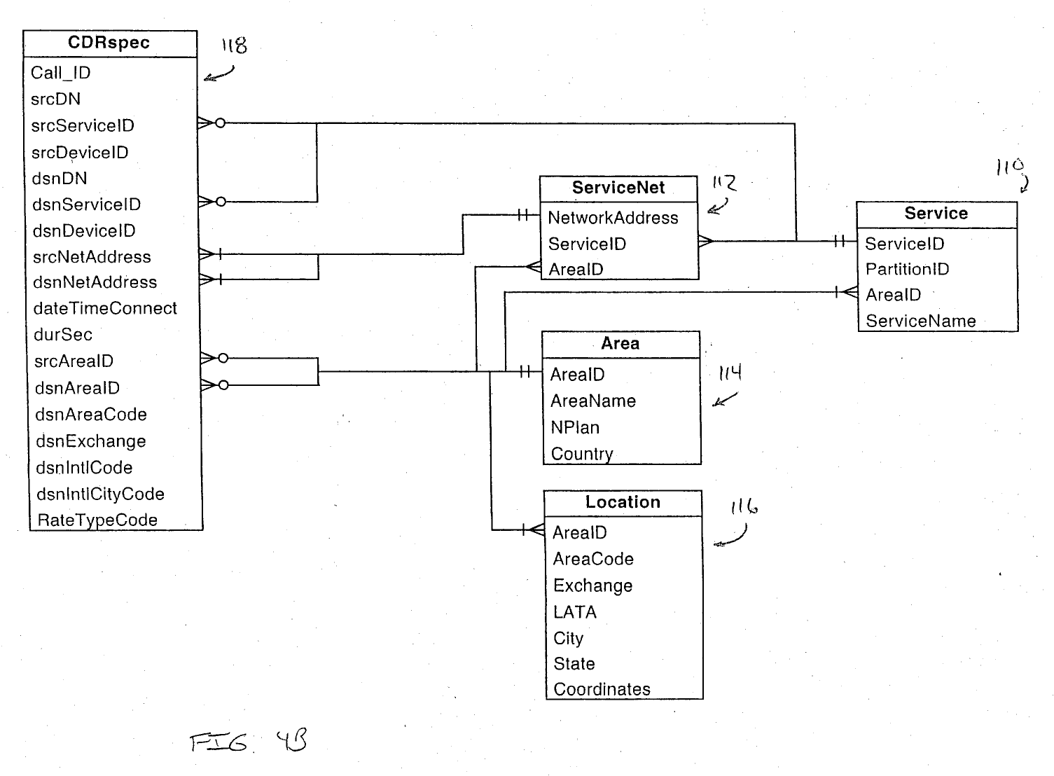

FIGS. 4A and 4B are entity-relationship diagrams illustrating associations between two or more entity instances, and is a static view of the system. In describing FIGS. 4A and 4B, the abbreviations illustrated in Table I are used.

TABLE I
Abbreviations

| Abbreviation | Definition |
|---|---|
| DN | Directory Number |
| Dsn | Destination |
| ID | Identifier |
| Intl | International |
| Net | Network |
| Nplan | Number Plan |
| Src | Source |
| LATA | Local Access Transport Area |

The entities in FIGS. 4A and 4B are, in one embodiment, tables in a database with entries that may be mandatory (obligatory) or optional. Furthermore, the entries in the tables are related by one-to-one, one-to-many, or many-to-many relationships. These entries may be referred to as multiple rather than many, and the term “unique” can be used to refer to an entry which is unique to a table and which may be related to another unique entry in a table (a one-to-one relationship) or many entries in another table (a one-to-many relationship).

Referring to FIG. 4A, entries in the CallDetailRecord table 100 may have relationships with the Partition table 102 and Device 104 table such that the PartitionID in the In a preferred embodiment, the partition table is mandatory and has a one-to-many relationship to the optional srcPartitionID and optional dsnPartition entries in the CallDetailRecord. This represents the fact that although the PartitionID must exist, the srcPartitionID and dsnPartitionID may or may not exist, and if they do exist, one PartitionID may be related to multiple srcPartitionIDs or dsnDeviceIDs.

Similarly, the PartitionID entry in the Partition table 102 may be related to multiple, mandatory PartitionIDs in the Device table 104. The optional and unique DeviceID in the Device table can be related to multiple (optional) dsnDeviceIDs and srcDeviceIDs in he CallDetailRecord.

Referring to FIG. 4B, in a preferred embodiment entities in the Service table 110, ServiceNet table 112, Area table 114, Location table 116, and CDRspec table 118 are related by the relationships illustrated and described herein. The preferred embodiment's mandatory ServiceID is unique and can correspond to many ServiceIDs in ServiceNet, and many optional srcServiceIDs and dsnServiceIDs in CDRspec 118. Since not all NetworkAddresses are necessarily mapped, the Service IDs and AreaIDs in the ServiceNet table may or may not exist.

Within the ServiceNet table 112, the preferred embodiment's mandatory NetworkAddress entry is preferably related to many mandatory srcNetAddresses and dsnNetAddresses in the CDRspec 118.

There can be many (optionally mandatory) AreaIDs in the Service table 110, and they may be related to the unique and preferably mandatory AreaID in the Area table 114, preferably mandatory multiple AreaIDs in the Location table 116, and many optional srcAreaIDs and dsnAreaIDs in the CDRspec 118.

AreaID in the Area table 114 is preferably related to many optional srcAreaIDs and dsnAreaIDs in CDRspec 118. AreaID in the Area table 114 may also be related to many (optional) srcNetAddresses and dsnNetAddresses in CDRspec 118, and many preferably mandatory AreaIDs in the Location table 116.

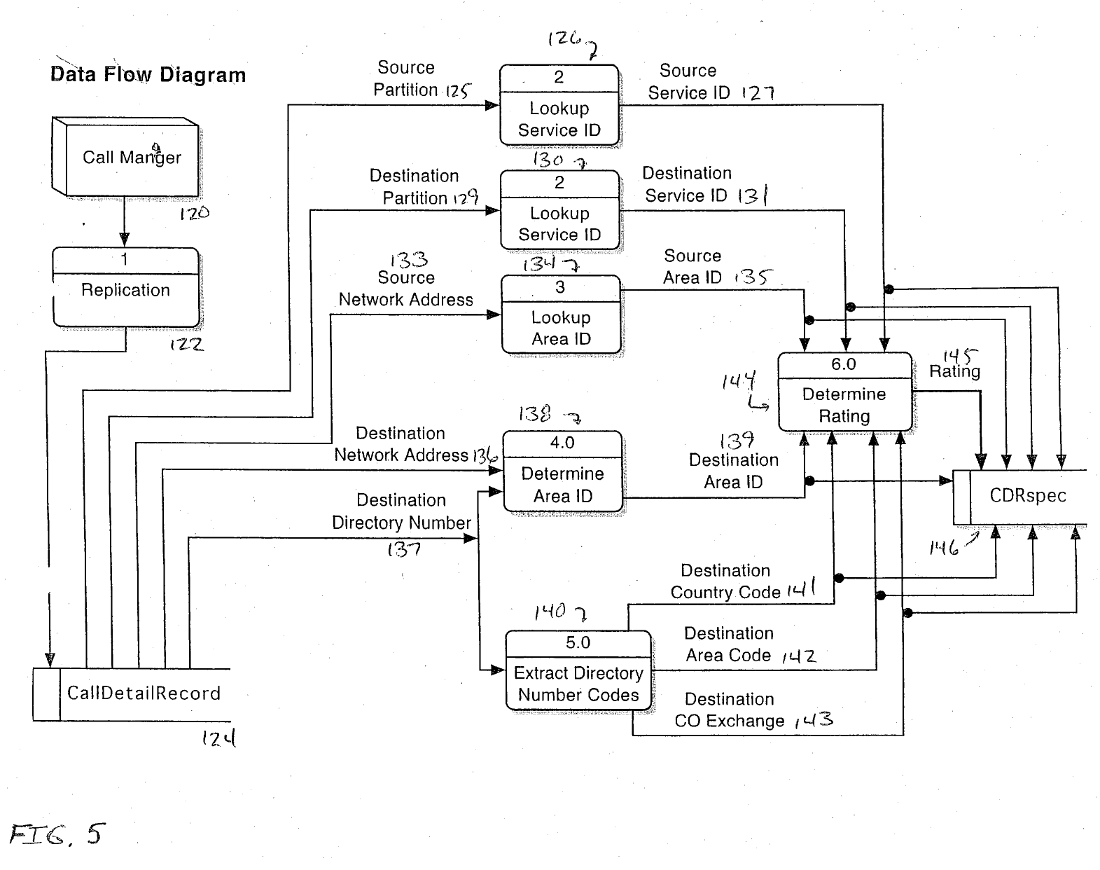

FIG. 5 is a data flow diagram that shows data flow between entities (such as data sources/sinks), processes, and data stores in a preferred embodiment. As shown in FIG. 5, information is received from the call manager 120 and used by the Replication process 122 to create a CallDetailRecord data store 124. From the CallDetailRecord data store 124 the Source Partition 125 is used by the Lookup Service ID 126 process to determine a Source Service ID 127. As used herein, a partition refers to an arbitrary grouping of telephony devices, such as grouping by geographic location and/or customer. A service refers to a customer, billing group, location entity, and/or other association for the service.

In one embodiment the Lookup Service ID process 126 preferably maps a Source Partition 125 to a Source Service ID 127 on a one-to-one basis. In this mapping, the partitions side contains data relevant to the telephony network (packet based or circuit switched), and the services side contains data relevant to billing.

The Lookup Service ID process 130 of FIG. 5 takes a Destination Partition 129 and maps it to a Destination Service ID 131. The Lookup Area ID process 135 of FIG. 5 takes the Source Network Address 133 and maps it to a Source Area ID 135.

The Determine Area ID process 138 of FIG. 5 relates the Destination Network Address 136 to a Destination Area ID 139 in the case of a call which is entirely packet based, or a Destination Directory Number 137 to a Destination Area ID 139 when the telephony device does not have a network address (e.g. when the telephony device is a traditional PSTN phone).

The Extract Directory Number Codes process 40 shown in FIG. 5 takes the Destination Directory Number 137 and extracts the pertinent parts of the dial string such as the Destination Country Code 141, the Destination Area Code 142, and the Destination CO Exchange 143.

The Determine Rating process 144 takes the data inputs indicated in FIG. 5 and produces a Rating 145 which is stored, along with other data, in the CDRspec data store 146 or other appropriate memory location.

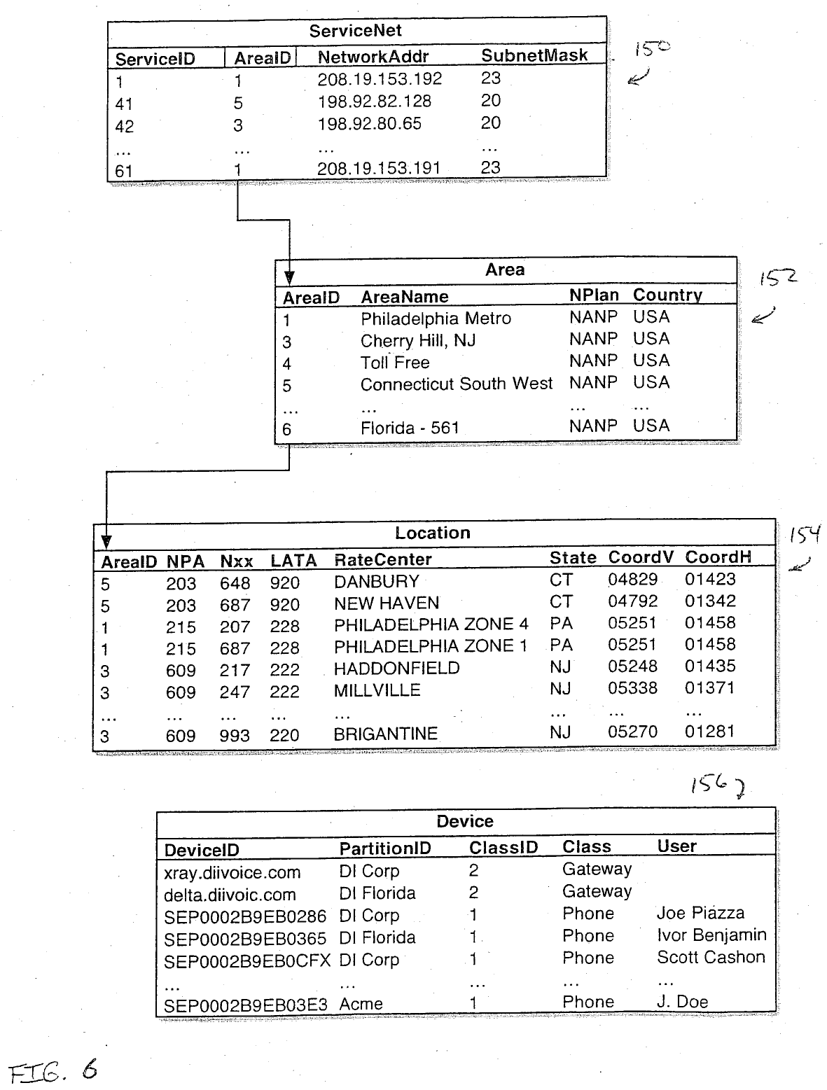

FIG. 6 illustrates tables which relate IP addresses to locations/LATAs, device addresses to IP addresses, and source/destination number to location mapping. The ServiceNet table 150 of FIG. 6 relates ServiceID, AreaID, NetworkAddr and SubnetMask. The AreaID of the ServiceNet table is then related to the Area table 152, which contains the AreaName, numbering plan (NPlan) and Country.

The AreaID can also be related to the Location table 154, which determines the specific location as described on the PSTN including area code (NPA), exchange (Nxx), Local Access and Transport Area (LATA), RateCenter, State, and Coordinates.

The Device table 156 in FIG. 6 relates a DeviceID (e.g. a Media Access Control or MAC address) with other network information including the PartitionID, ClassID, Class, and User.

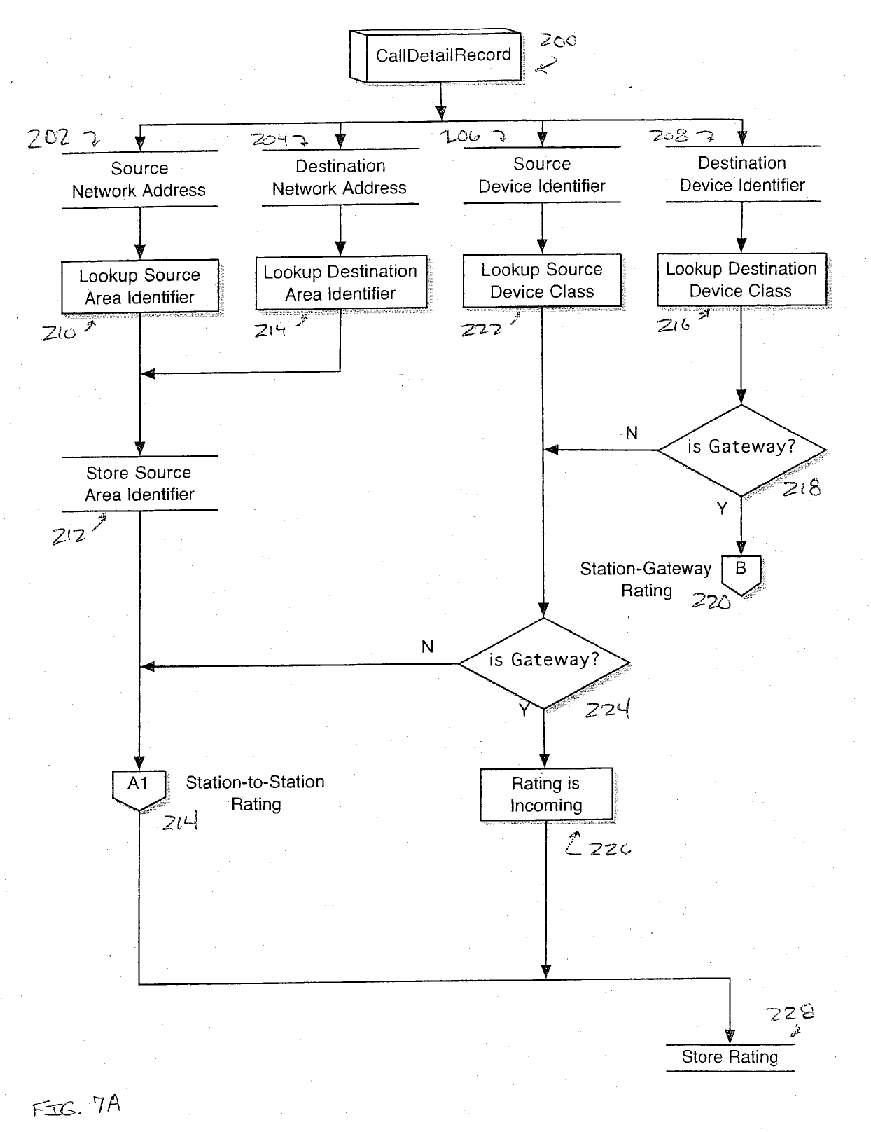

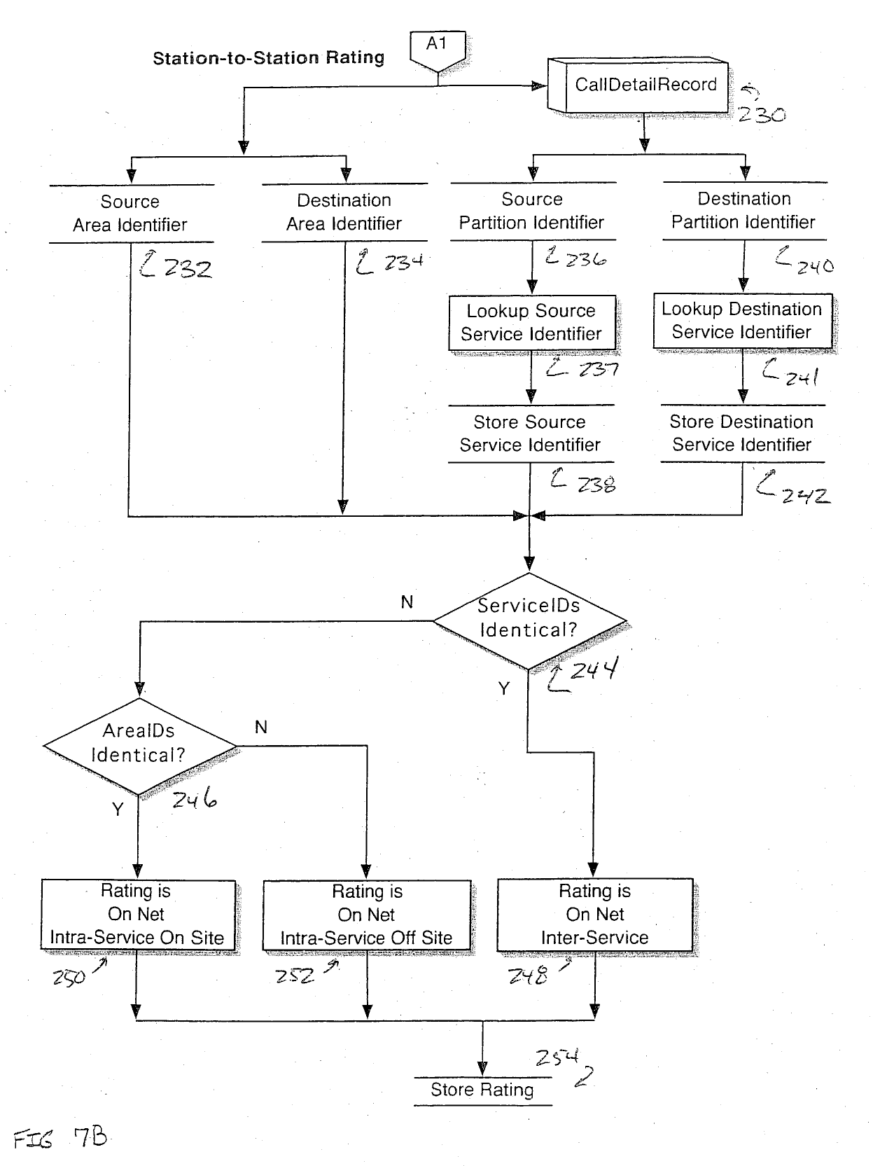

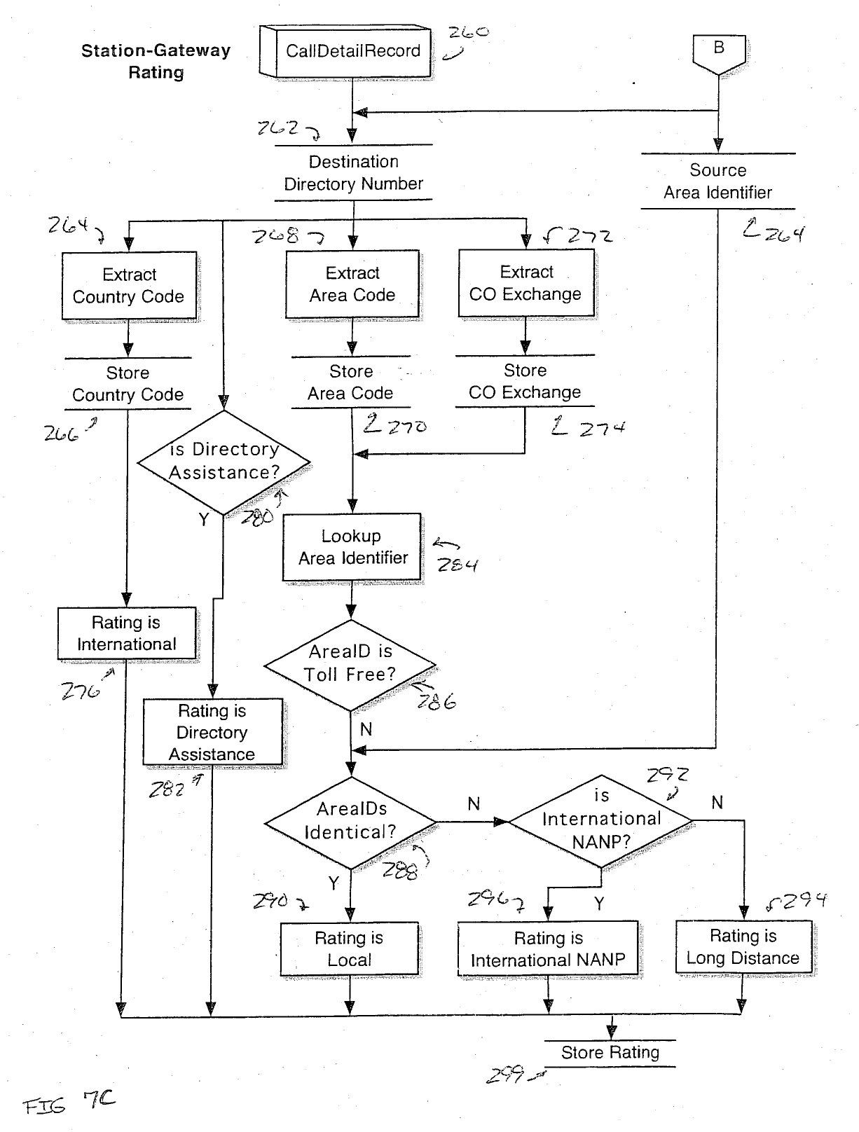

FIGS. 7A-7C represent flowcharts for call rating and billing, respectively, in a preferred embodiment. Referring to FIG. 7A, a call detail record 200 is processed to determine the Source Network Address 202 and Device Identifier 204 and Destination Network Address 206 and Device Identifier 208. In the case of a pure packet (IP) telephony call, the Source Area Identifier is stored 212 and a Station-to-Station rating process (A1) 214 can be performed. In the case that the Destination Device Class indicates that the destination device is a gateway 218, a Station-Gateway Rating process (B) 220 is performed. If it is determined that the Source Device Class indicates that the source is a gateway 224 then the call is simply designated as Incoming 226, and the rating process is complete. The rating is then preferably stored in a memory 228.

Referring to FIG. 7B, the Station-to-Station Rating process A1 is described. The CallDetailRecord 230 is accessed to determine the Source Area Identifier 232 and Destination Area Identifier 234 directly or through the Source 236 and Destination 240 Partition Identifiers respectively. A test 244 is then performed to determine if the Service IDs are identical. If so, the call is rated as an On Net Inter-Service call 248. If it is not determined that the ServiceIDs are identical in a ServiceIDs Identical test 244, an AreaIDs Identical test 246 is performed to determine if the AreaIDs are Identical. If so, the call is rated as an On Net Intra-Service On Site call 250. If the AreaIDs are not identical the call is rated as an On Net Intra-Service Off Site call 252. The rating is stored in a Store Rating step 254 as illustrated in FIG. 7B.

The Station-Gateway rating is shown in FIG. 7C and illustrates how a Destination Directory Number 262 is used to extract and store the Country Code 264/266, Area Code 268/270, and CO Exchange 272/274. Based on the Country Code, the call can be rated as International 276 if applicable. A Directory Assistance test 280 may be performed to determine if the call should be rated as a Directory Assistance call 282.

A LookupArea Identifier step 284 is used as illustrated in FIG. 7C to determine the Area Identifier, and a subsequent test may be performed to determine if the AreaID is toll free 286. If the AreaID is not toll free, the rating process continues with an Area IDs Identical Test 288. If the AreaIDs are identical, the call rating is Local 290. If the AreaIDs are not Identical, a test is performed to determine if the call is International or Long Distance 292, with the call to be rated appropriately 296/298 and stored 299.

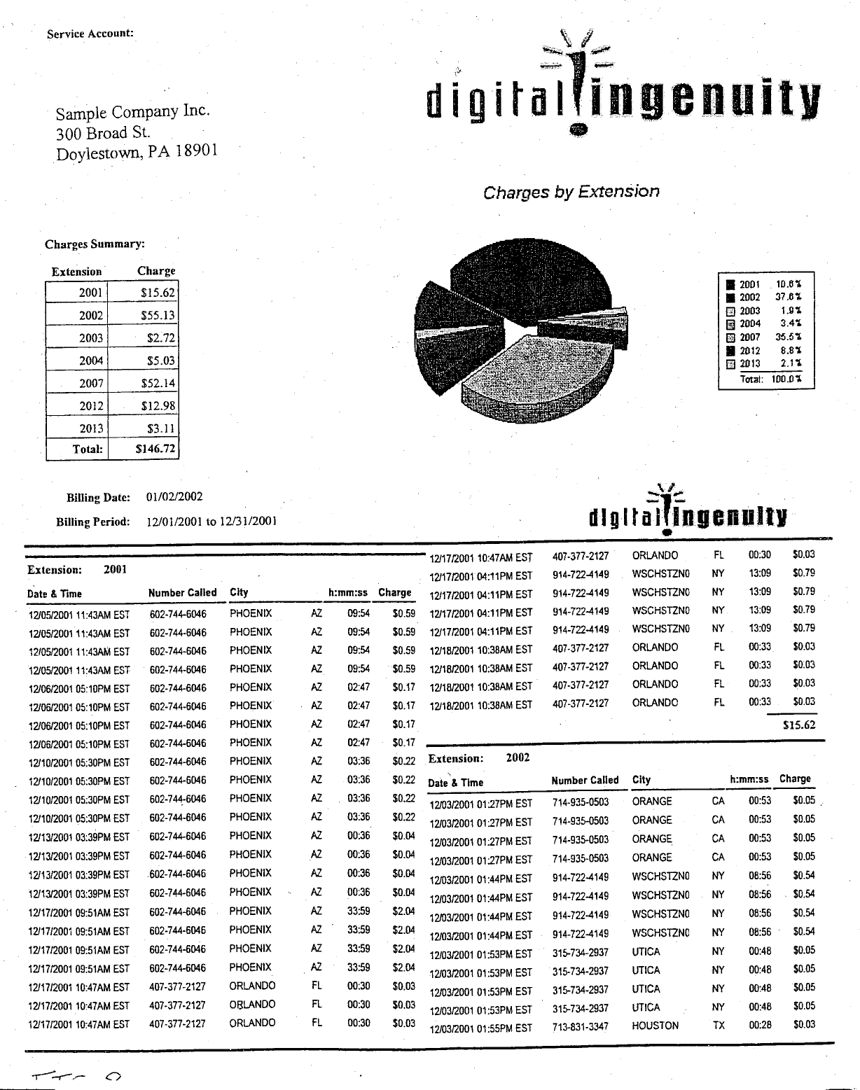

FIG. 8 illustrates a representative phone bill that can be generated based on the rating process. Based on the rating, a service plan is applied and determines the actual charge for the call. The charge may be based on the rating as well as other factors including the time of day and other parameters as determined by that customer's calling plan. As previously illustrated in FIG. 3, in a preferred embodiment the Call Rating and Billing System accesses the Rating Rules and Service Plans to determine how to charge the customer for each call. The Billing Interface works in conjunction with the Call Rating and Billing System to produce the representative phone bill illustrated in FIG. 8.

In a preferred embodiment, the present invention uses Unified Modeling Language (UML) and combinations of UML with traditional flowcharts to illustrate the operation of the method and system. UML is only used as an aid to understand the invention and does not constrain the implementation in any way. The invention can be implemented on a wide variety of computing and networked computing platforms, including servers running operating systems based upon Microsoft Corporation's Windows, open source or proprietary variants of Linux, Sun Microsystems Solaris, Hewlett-Packard's hp-ux and other variations of UNIX (including but not limited to System V based operating systems) or other operating systems. Queries can be constructed using, for example, Structure Query Language (SQL) to perform operations on databases such as the database products offered by Microsoft Corporation under the trademark of SQL Server. Object oriented code such as C++ or Java can be used to query databases and perform the steps of the invention. Alternatively, procedural languages such as C can be used to create programs which perform the rating and billing functions described herein. Other combinations of servers, databases, and programming languages can be used to realize the present invention, as will be readily understood by those skilled in the art.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

The many features and advantages of the invention are apparent from the detailed specification. Thus, the invention is intended to include all such features and advantages of the invention which fall within the true spirits and scope of the invention. Further, since numerous modifications and variations will readily occur to those skilled in the art, it is not desired to limit the invention to the exact construction and operation illustrated and described in the specification, claims, and drawings herein. Accordingly, all appropriate modifications and equivalents may be included within the scope of the invention.

What is claimed is:

1. A method for rating a packet based communication, the method comprising the steps of:
extracting a first portion of data from a detail record corresponding a packet based communication, wherein the first portion contains at least a first network address;
extracting a second portion of data from the detail record, wherein the second portion contains at least a second network address;
retrieving a mapping, wherein the mapping relates the first network address to a first location and the second network address to a second location; and
rating the packet based communication in a service class based on at least the first location and the second location.

2. The method of claim 1 wherein the first network address is an Internet Protocol (IP) address and the second network address is a gateway between a digital network and an analog network.

3. The method of claim 1 wherein the first network address and second network address are both Internet Protocol (IP) addresses.

4. The method of claim 1 wherein the service class is selected from the group consisting of directory assistance, toll free, 900/976 numbers, emergency, intra service (on site), intra service (off site), inter service, local calls, long distance domestic calls, long distance international calls, and international calls.

5. A method for rating a packet based telephone call and assigning the call to a user, the method comprising the steps of:
extracting a first portion of data from a detail record corresponding to a packet based communication, wherein the first portion contains at least a first network address representing a first station;
extracting a second portion of data from the detail record, wherein the second portion contains at least a second network address representing a second station;
extracting a third portion of data from the detail record, wherein the third portion contains at least a first device identifier associated with the first station;
retrieving a first mapping, wherein the first mapping relates the first network address to a first location and the second network address representing a second station;
rating the packet based communication in a service class based on at least the first location and the second location;
retrieving a second mapping, wherein the second mapping relates the first device identifier with a user; and
assigning the communication to the user.

6. The method of claim 5 wherein the first network address is an Internet Protocol (IP) address and the second network address is a gateway between a digital network and an analog network.

7. The method of claim 5 wherein the first network address and second network address are both Internet Protocol (IP) addresses.

8. The method of claim 5 wherein the device identifier is a Media Access Control (MAC) address.

9. A method for rating a call in a packet based environment having at least one packet based telephony gateway, the method comprising the steps of:
extracting a first portion of data from a call detail record corresponding to a packet based telephone call, wherein the first portion contains at least a first network address;
extracting a second portion of data from the call detail record, wherein the second portion contains at least a directory number;
relating the first network address to a first location;
relating the directory number to a second location; and
rating the call in a service class based on at least the first location and the second location.

10. The method of claim 9 wherein the first network address is an Internet Protocol (IP) address.

11. A method for rating a packet based telephone call, the method comprising the steps of:
extracting a first portion of data from a record corresponding to a packet based telephone call, wherein the first portion contains at least a first network address representing a first station;
extracting a second portion of data from the record, wherein the second portion contains at least a directory number;
extracting a third portion of data from the record, wherein the third portion contains at least a first device identifier associated with the first station;
relating the first network address to a first location;
relating the directory number to a second location;
rating the call to place the call in a service class based on at least the first location and the second location;
relating the first device identifier with a user; and
assigning the call to the user.

12. A method for rating a communication that is transmitted over a packet based network comprising the steps of:
determining a source identifier for a communication that is transmitted over a packet based network;
determining a destination identifier for a communication; and
rating the communication based on a relation of the source identifier to the destination identifier.
